(19) United States
(12) Patent Application Publication
(10) Pub. No.: US 2002/0078896 A1
(43) Pub. Date: Jun. 27, 2002

(54) Feed conveying system

(76) Inventor: Kazumi Fujii, Gunma (JP)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/883,274

(22) Filed: Jun. 19, 2001

(30) Foreign Application Priority Data
Dec. 25, 2000 (JP) 2000-393491

(51) Int. Cl. A01K 61/02

(52) U.S. Cl. 119/52.1

(57) ABSTRACT

A feed conveying system, in which a disk cable is not easily dislocated from a drive sprocket or get fatigued to break in a short period, and feed S returned does not disturb the operations of the drive sprocket and others, is provided. A cable inlet port is formed at the top end of a side wall and a cable outlet port is formed at the bottom end of a side wall. The drive sprocket is disposed at an upper one side portion within a housing, and a free pulley is disposed at a lower other side portion on a substantially same plane as the drive sprocket so to be freely movable in a horizontal direction, and a weight for applying a tensile force to the free pulley is disposed. A feed guide member, which has a drop frame section falling between the drive sprocket and the free pulley connected to a guide cylindrical section extending from the cable inlet port, is disposed. A drive device having the above component members is disposed in the feed conveying system.

### BACKGROUND OF THE INVENTION

### Field of the Invention

The present invention relates to a feed conveying system which conveys feed from a feed hopper to a plurality of feeders through a pipeline by running an endlessly connected disk cable in the pipeline.

### Related Art Statement

Conventionally, as a feed conveying system provided with pipelines, there is known a disk cable type feed conveying system 101 as shown in FIG. 6 wherein an endlessly connected disk cable 102 is inserted into a pipeline 103 and forwarded in a direction of arrow X by a drive device 104 to convey feed S, which is charged between disks 102b of the disk cable 102 from a feed hopper 105, and is conveyed to distribute into feeders 107 through feed drop pipes 101.

The disk cable 102 has the disks 102b fixed at predetermined intervals to a flexible wire 102a as shown in FIG. 7.

Conveying resistance is high at corners 103a where the pipeline 103 is bent at about right angles in a vertical or horizontal direction, so that in order to lower the resistance, corner joints 108 having a wheel therein are disposed at the corners 103a as shown in FIG. 8.

As shown in FIG. 8, the drive device 104 has a drive sprocket 110 disposed within a housing 109, the disk cable 102 is put around the drive sprocket 110, and the drive sprocket 110 is driven by a drive motor 111 to run the disk cable 102.

To always keep the disk cable 102 tight and run securely by the drive sprocket 110, a disk cable tensioning mechanism 112 is configured by disposing a free pulley 113 in the housing 109, also putting the disk cable 102 around the free pulley 113, and pulling the free pulley 113 by a spring 114 via a support member 115 to keep the disk cable 102 under a tension.

In the conventional drive device 104, the drive sprocket 110 is tilted by a predetermined angle as shown in FIG. 8(B) so that the disk cable 102 moving in a direction y is prevented from having a mutually overlapped portion between the drive sprocket 110 and the free pulley 113 as shown in FIG. 8(A). Therefore, the disk cable 102 must be always kept under a high tension to prevent a possibility that the disk cable 102 is dislocated from the drive sprocket 110.

Because the drive sprocket 110 is tilted by the predetermined angle and the disk cable 102 is always kept under high tension, a load applied to the drive sprocket 110 and the disk cable 102 is extremely high, and a large driving force is required to drive the drive sprocket 110. Accordingly, the disk cable 102 becomes fatigued and is easily broken in a relatively short period.

When the disk cable 102 is stretched and has a low tension by long-term use or the disk cable 102 vibrates greatly during its normal use, the disk cable 102 is sometimes displaced from the drive sprocket 110. Besides, a high load is sometimes applied to the disk cable 102 as shown in FIG. 9(A) or the disk cable 102 is sometimes broken as shown in FIG. 9(B) for some reason.

Therefore, in order to detect that the disk cable 102 comes off, is put under a heavy load or is broken, an operation rod 116 is fixed to the support member 115, and limit switches 117, 118 are disposed at appropriate positions for constant monitoring in the housing 109. And, if the disk cable 102 comes off, is put under a heavy load or is broken, an operator replaces it in position and readjust it immediately. But, such replacing and adjusting works are quite troublesome because the disk cable 102 is put around the drive sprocket 110 and the free pulley 113.

Because of its mechanical structure, the conventional drive device 104 must be disposed at a position of the pipeline 103 where the feed S is substantially not present, namely at a position immediately before the feed hopper 105 where the feed S is supplied to all the feeders 107. But, the feed S cannot be necessarily conveyed according to the theory, and the feed S having returned through the pipeline 103 is gradually accumulated in the drive device 104 and enters the coil section of the spring 114 and the axes of the drive sprocket 110 and free pulley 113 to disturb their operations.

### SUMMARY OF THE INVENTION

The present invention was achieved to remedy the disadvantages of the aforesaid conventional feed conveying system. And, it is an object of the invention to provide a feed conveying system wherein a disk cable does not come off from a drive sprocket even if the disk cable is not always kept under a heavy tension within a drive device, the drive sprocket is driven without requiring an extremely high driving force, and the disk cable does not become fatigued and is not broken in a short time. For example, even if the disk cable comes off, becomes under a heavy load or is broken, it can be easily replaced on the drive sprocket and readjusted, and the returned feed S is not gradually accumulated in the drive device to disturb the operations of the drive sprocket and the like.

To achieve the above object, the feed conveying system of the invention is characterized by comprising a drive device having a housing which has a cable inlet port at the top end of its one side wall and a cable outlet port at the bottom end of the other side wall, a drive sprocket which is disposed at an upper one side in the housing, a free pulley which is disposed at a lower other side on a substantially same plane as the drive sprocket in the housing so to be freely movable in a horizontal direction, a weight which applies a tensile force to the free pulley, and a feed guide member which has a drop frame section falling between the drive sprocket and the free pulley connected to a guide cylindrical section extending from the cable inlet port.

### BRIEF DESCRIPTION OF THE DRAWINGS

FIG. 1 is a general perspective view of the feed conveying system of the present invention;

FIG. 2 is a front sectional view of a drive device used for the feed conveying system of FIG. 1;

FIG. 3 is a sectional view taken along line A-A of FIG. 2;

FIG. 4 is a sectional view taken along line B-B of FIG. 2;

FIG. 5 is a sectional view taken along line C-C of FIG. 2;

FIG. 6(A) is a front view and FIG. 6(B) is a side sectional view of a drive sprocket;

FIG. 7 is a general perspective view of a conventional feed conveying system;

FIG. 8 is a front view of a part of a disk cable;

FIG. 9(A) is a front sectional view and FIG. 9(B) is a side sectional view of a drive device used for the feed conveying system of FIG. 7;

FIG. 10(A) is a front sectional view showing a state under a heavy load and FIG. 10(B) is a front sectional view showing a state with a wire broken of the drive device of FIG. 9.

### DETAILED DESCRIPTION OF THE INVENTION

A preferred embodiment of the feed conveying system of the invention will be described specifically with reference to the accompanying drawings.

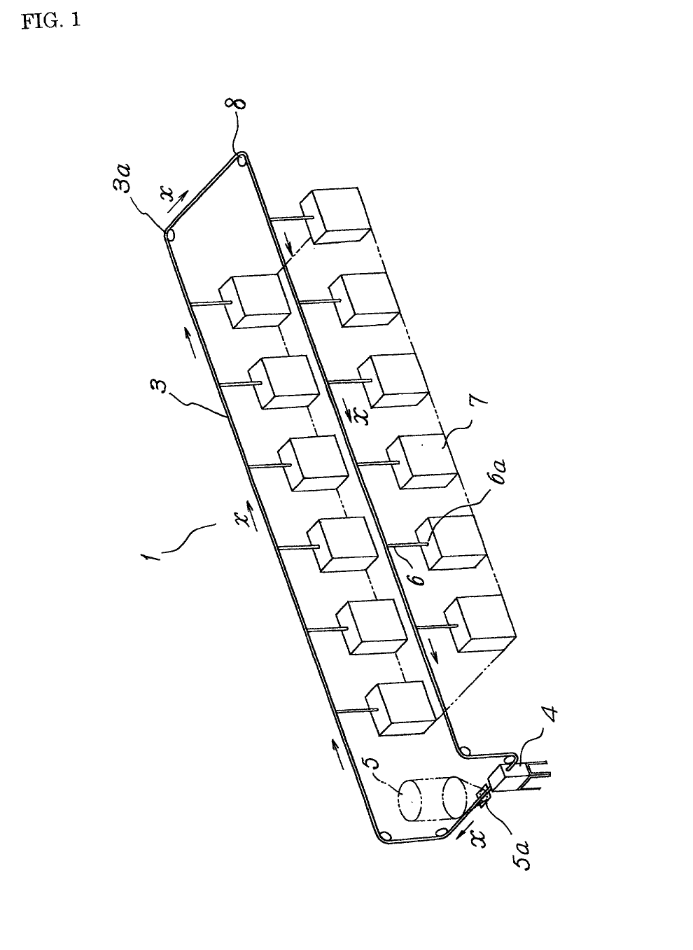

A feed conveying system 1 of the present invention has a plurality of feeders 7, 7, . . . disposed via feed drop pipes 6, 6, . . . which are disposed at predetermined intervals on an endlessly connected pipeline 3 and a disk cable 2, which has disks 2b fixed at predetermined intervals to an endlessly connected flexible wire 2a, passed through the pipeline 3, and runs the disk cable 2 in a direction of an arrow x by a drive device 4 as shown in FIG. 1.

In the drawing, a feed charging port 5a is formed at the bottom end of a feed hopper 5 indicated by an alternate long and short dash line, and a feed drop port 6a is formed at the bottom ends of the feed drop pipes 6. The feed S is charged into the pipeline 3 through the feed charging port 5a, conveyed by the disk cable 2 through the pipeline 3 and supplied into the feeders 7 through the feed drop ports 6a. Corner joints 8 having a wheel therein are disposed at corners 3a of the pipeline 3.

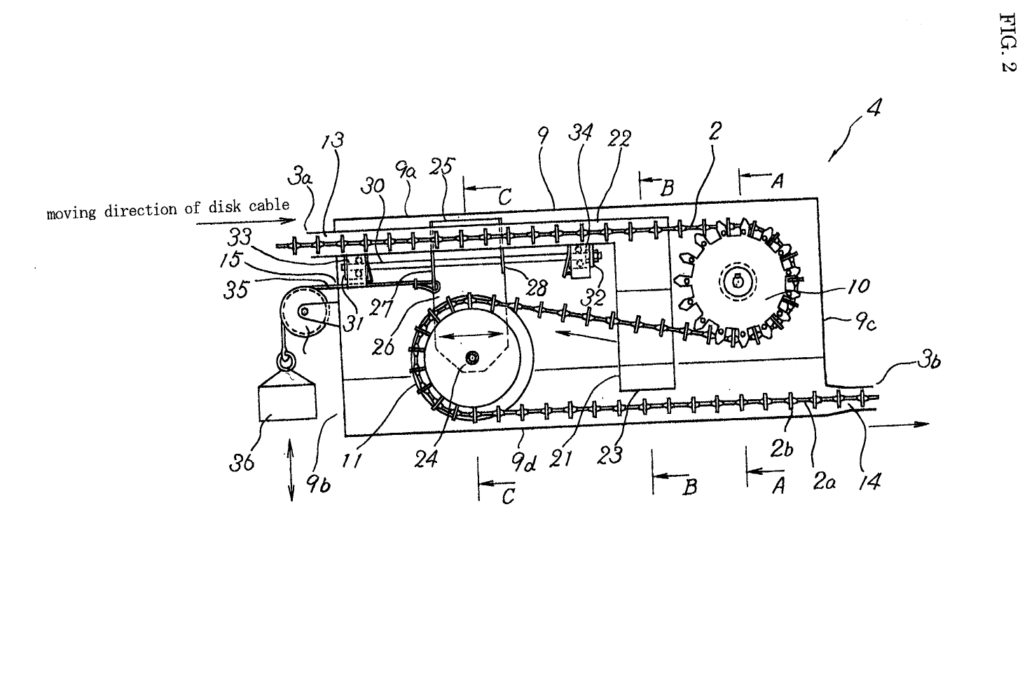

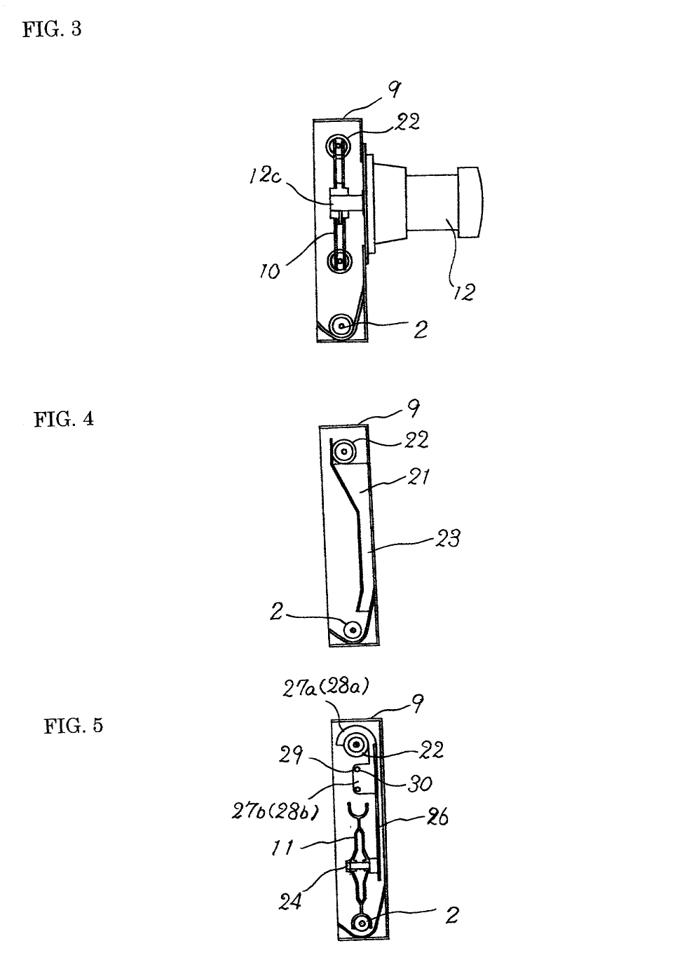

The drive 4 has a drive device sprocket 10 and a free pulley 11 which are disposed on a substantially same plane in a housing 9 and the disk cable 2 which is put around the drive sprocket 10 and the free pulley 11 in a Z form, and drives the drive sprocket 10 by a drive motor 12 to run the disk cable 2 as shown in FIG. 2.

The housing 9 is comprised of a top wall 9a, side walls 9b, 9c, a bottom wall 9d, a front wall 9e and a back wall 9f. A cable inlet port 13 is formed at the top end of the side wall 9b, and a cable outlet port 14 is formed at the bottom end of the side wall 9c. And, a wire insertion port 15 is formed at the middle portion of the side wall 9b.

And, one ends of respective pipes 3a, 3b are connected to the cable inlet port 13 and the cable outlet port 14.

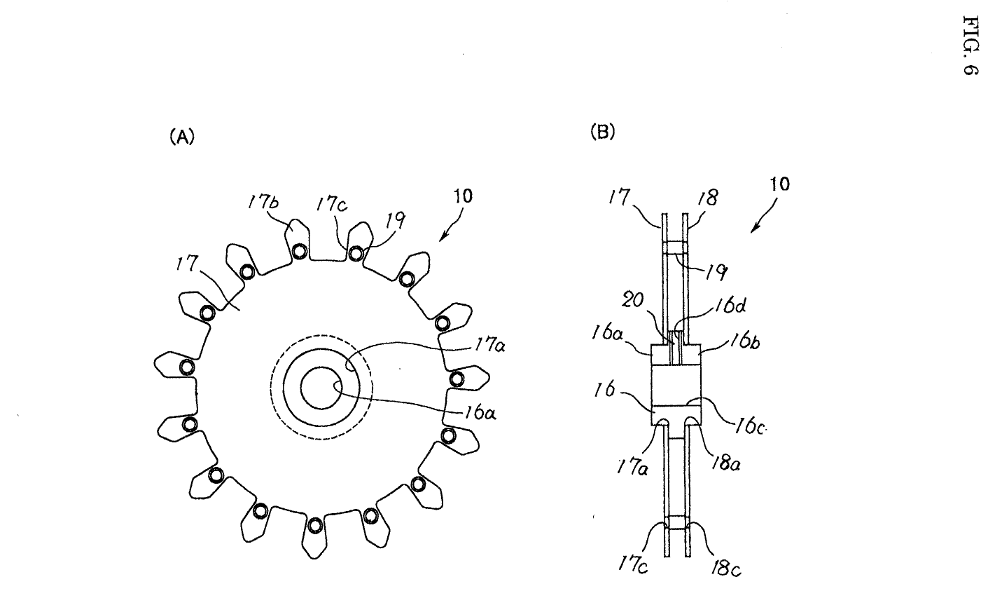

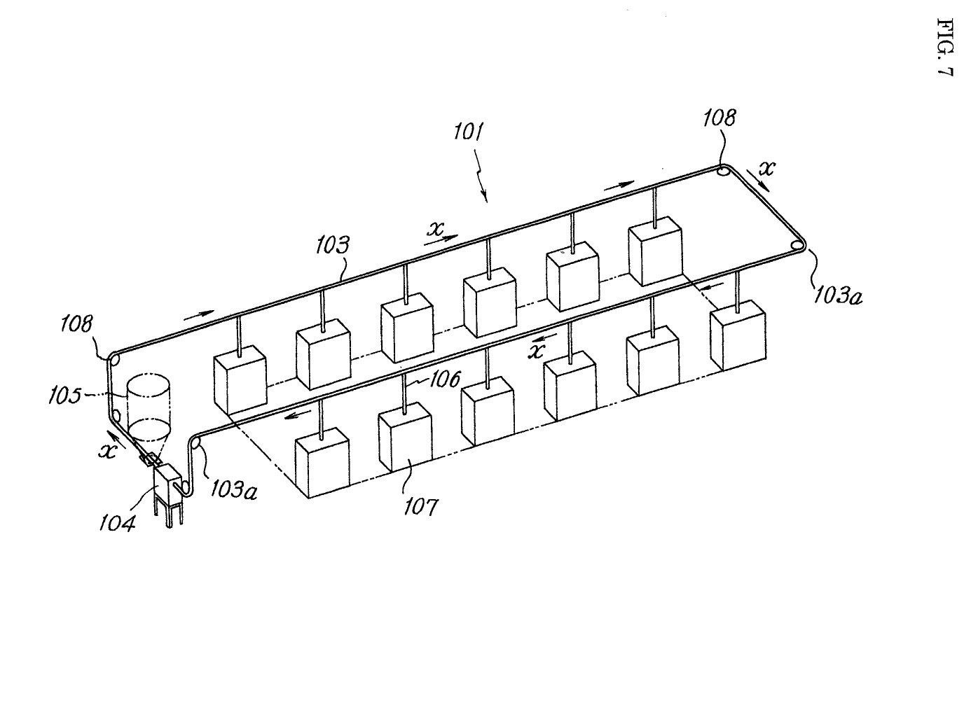

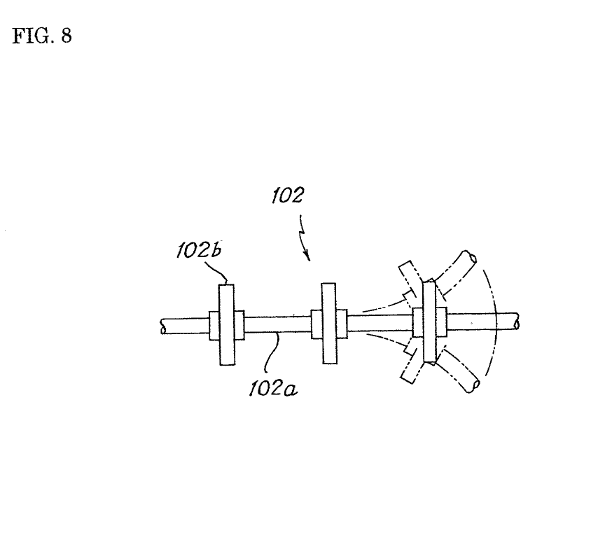

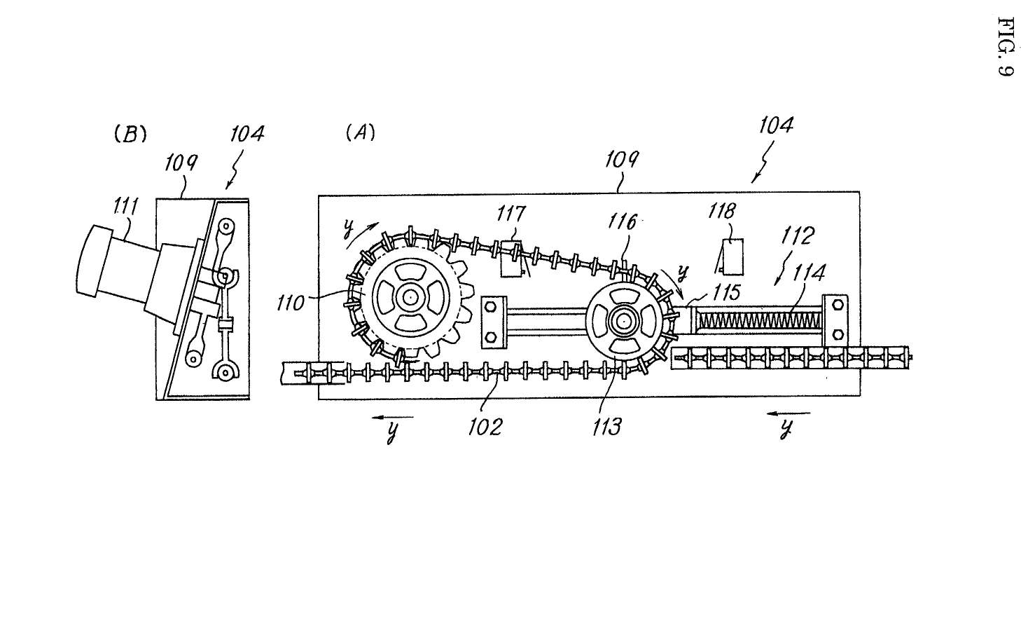

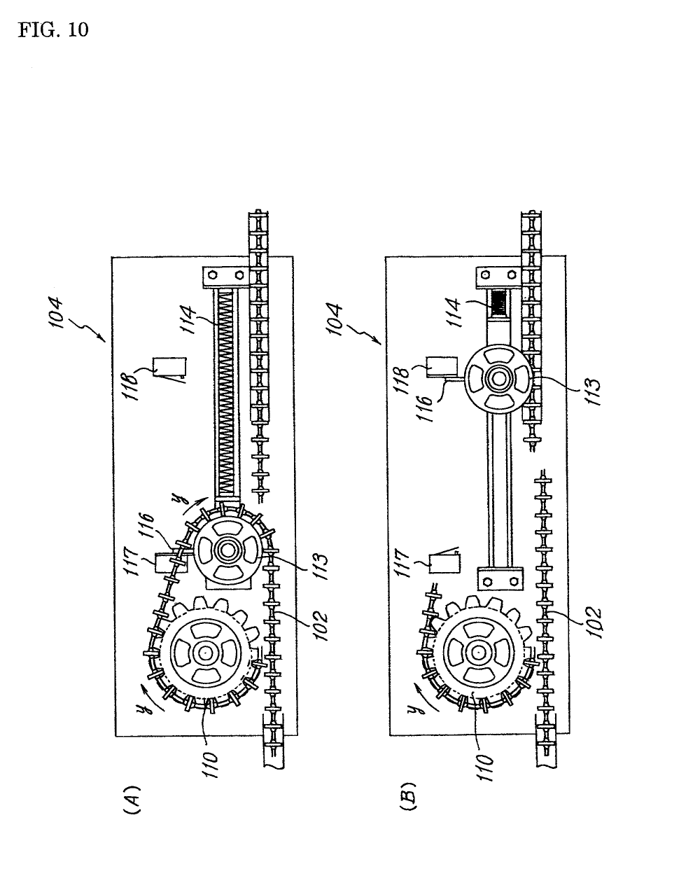

The drive sprocket 10 is disposed at the upper right portion in the housing 9 and comprised of a support 16, operation plates 17, 18 and joint pins 19, 19 . . . as shown in FIG. 6.

The support 16 is formed projections 16a, 16b on its both sides, an insertion hole 16c at the center and a screw hole 16d is formed in a direction perpendicular to the insertion hole 16c.

The operation plates 17, 18 are respectively formed fitting holes 17a, 18a at the center, special shape teeth 17b, 18b on the periphery, and joint holes 17c, 18c are formed on the respective teeth 17b, 18b.

The projections 16a, 16b of the support 16 are engaged with the fitting holes 17a, 18a of the operation plates 17, 18 and fixed by welding or the like. The operation plates 17, 18 are mutually joined by fitting and welding or the like the both ends of the joint pins 19 to the joint holes 17c, 18c.

A drive shaft 12a of the drive motor 12 is inserted into the insertion hole 16c, and a stopper screw 20 is driven into the screw hole 16d to push the drive shaft 12a by the stopper screw 20. Thus, the drive sprocket 10 is fixed to the drive shaft 12a.

The special shape teeth 17b, 18b are different from those of a conventional drive sprocket, and a face width b is generally narrow as a whole but designed to be gradually wide from a dedendum toward the middle part and be gradually narrowed from the middle part toward the tip part as shown in FIG. 6. And, a space c between the adjoining teeth is larger than the face width b.

As shown in FIG. 2, a feed guide member 21 is disposed in the housing 9 and comprised of a guide cylindrical section 22 which is extended in a substantially horizontal direction and a drop frame section 23 which is bent in a substantially perpendicular direction.

The guide cylindrical section 22 has its one end connected to the pipe 3a and has the disk cable 2 run through it to guide and convey the feed in a substantially horizontal direction. The drop frame section 23 is located between the drive sprocket 10 and the free pulley 11 to guide to drop the conveyed feed S in a perpendicular direction.

The feed introduced into the housing 9 through the pipe 3a is conveyed by the disk cable 2 through the guide cylindrical section 22, dropped through the drop frame section 23 and discharged out of the housing 9 by the disk cable 2 through the pipe 3b.

The free pulley 11 is rotatably supported by a support member 25 via a support shaft 24, and the support member 25 is comprised of a support plate 26 and guide pieces 27, 28.

The guide pieces 27, 28 have round portions 27a, 28a at their upper part respectively to engage with the guide cylindrical section 22 and their lower part formed as rectangular portions 27b, 28b each with an insertion hole 29. And, a guide rod 30 is passed through the insertion holes 29, 29.

Thus, the free pulley 11 is freely movable in a horizontal direction by being guided by the guide cylindrical section 22 and the guide rod 30.

The guide rod 30 has its both ends fixed to the housing 9 by means of fixing members 31, 32 to which limit switches 33, 34 are fixed.

And, if the disk cable 2 is abnormally extended, broken or got under a heavy load, the guide pieces 27, 28 push operation rods 33a, 34a of the limit switches 33, 34 to stop the drive motor 12.

One end of a wire 35 is fixed to the rectangular portions 27b of the guide piece 27, the wire 35 is passed through the wire insertion port 15 of the side wall 9b, pulled out of the housing 9 and guided by a guide pulley 36. And, a weight 36 is fixed to and suspended from the other end of the wire 35.

Accordingly, the free pulley 11 is tensioned in a left direction by a weight of the weight 36 so to always apply an appropriate tension to the disk cable 2.

According to the present invention, the drive sprocket 10 and the free pulley 11 are disposed on a substantially same plane in the drive device 4, and the disk cable 2 is put around the drive sprocket 10 and the free pulley 11 in the Z form, so that it is not necessary to have any means for preventing the disk cable 2 from having an overlapped portion, and the disk cable 2 does not come off the drive sprocket 10 even if a high tension is not always applied to the disk cable 2.

And, because the drive sprocket 10 is not tilted and the disk cable 2 is not always kept under a high tension, a load applied to the drive sprocket 10 and the disk cable 2 does not become very large, so that a very large driving force is not required to drive the drive sprocket 10, and the disk cable 2 is not broken by a fatigue in a short period.

According to the drive device 4, even if the disk cable 2 is stretched by a long-term use, the free pulley 11 is moved in a horizontal direction by the weight of the weight 36 and the disk cable 2 is always tensioned appropriately by the weight of the weight 36, so that the disk cable 2 is free from coming off the drive sprocket 10.

Even if the disk cable 2 comes off, its replacing and adjusting works are relatively easy because the disk cable 2 is put around the drive sprocket 10 and the free pulley 11 in the Z form.

Besides, according to the drive device 4, the feed S returned through the pipeline 3 is guided and conveyed by the feed guide member 21, dropped between the drive sprocket 10 and the free pulley 11 and discharged out of the housing 9 by the disk cable 2. therefore, the feed S is not gradually accumulated in the drive device 4 and does not enter the axes of the drive sprocket 10 and the free pulley 11 to prevent their operations.

What is claimed is:

1. A feed conveying system for conveying feed by running an endlessly connected disk cable through an endlessly connected pipeline, comprising a drive device having a housing which has a cable inlet port at the top end of its one side wall and a cable outlet port at the bottom end of the other side wall, a drive sprocket which is disposed at an upper one side in the housing, a free pulley which is disposed at a lower other side on a substantially same plane as the drive sprocket in the housing so to be freely movable in a horizontal direction, a weight which applies a tensile force to the free pulley, and a feed guide member which has a drop frame section falling between the drive sprocket and the free pulley connected to a guide cylindrical section extending from the cable inlet port.

2. The feed conveying system according to claim 1, wherein the free pulley is supported by a support member for freely moving it in a horizontal direction and the weight is suspended from one end of a wire whose other end is fixed to the support member.
